(19) United States
(12) Patent Application Publication
(10) Pub. No.: US 2023/0070864 A1
(43) Pub. Date: Mar. 9, 2023

(54) Systems and Methods for Relaying Data Between Hearing Devices

(71) Applicant: SONOVA AG, Staefa (CH)

(72) Inventors: Alessandro Gallo, Murten (CH); Amre El-Hoiydi, Neuchâtel (CH); Federico Ferrari, Bern (CH)

(21) Appl. No.: 17/799,207

(22) PCT Filed: Feb. 24, 2020
(86) PCT No.: PCT/IB2020/051560

§ 371 Date: Aug. 11, 2022

(51) Int. Cl. H04R 25/00; H04W 4/80

(52) U.S. Cl. CPC H04R 25/554; H04W 4/80

(57) ABSTRACT

An exemplary hearing device is configured to receive, from a source, sequential data packets each identified by a sequence number. The hearing device receives, from an additional hearing device configured to also receive the sequential data packets, a first particular sequence number indicating a last of the sequential data packets received without discontinuity by the additional hearing device. The hearing device selectively transmits, based on the first particular sequence number and to the additional hearing device, a data packet included in the sequential data packets received from the source, the data packet identified by a sequence number that is based on the first particular sequence number.

### BACKGROUND INFORMATION

In some situations, it is desirable for a hearing system that includes first and second hearing devices to render (e.g., acoustically present) streaming audio from an audio source (e.g., a Bluetooth-enabled smartphone) to a user. To this end, the first hearing device may establish a wireless link (e.g., a Bluetooth link) with the audio source and receive audio packets transmitted from the audio source over the wireless link in accordance with an acknowledgement-based transmission protocol. The acknowledgement-based transmission protocol requires the first hearing device to acknowledge successful receipt of an audio packet transmitted by the audio source before the audio source transmits a subsequent audio packet.

For various reasons (e.g., technical limitations, power consumption constraints, etc.), it may be impossible or undesirable for the second hearing device to establish and maintain its own wireless link with the audio source while a wireless link is maintained between the first hearing device and the audio source. In these situations, as described in U.S. Patent Publication 2015/0319557, to facilitate rendering of the streaming audio by the second hearing device, the first hearing device may transmit eavesdropping instructions to the second hearing device by way of a wireless support link that interconnects the hearing devices. The eavesdropping instructions allow the second hearing device to eavesdrop on the wireless link established between the first hearing device and the audio source to receive the audio packets while the audio packets are being transmitted by the audio source over the wireless link. The first and second hearing devices may store the audio packets in respective buffers as the audio packets are received and render the audio by playing back the audio packets from the buffers. However, audio packets transmitted by the audio source may not always be received correctly by both the first hearing device and the second hearing device.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary configuration in which a hearing system is configured to communicate with an audio source by way of a selectively established wireless link according to principles described herein.

FIG. 2 illustrates an exemplary configuration in which hearing devices included in a hearing system both receive audio packets from the audio source into buffers according to principles described herein.

FIGS. 3-5 illustrate exemplary diagrams of relaying audio data according to principles described herein.

FIG. 6 illustrates an exemplary method for relaying audio data according to principles described herein.

### DETAILED DESCRIPTION

Exemplary systems and methods for relaying data by hearing devices and systems are described herein. For example, a hearing device may comprise a memory storing instructions and a processor communicatively coupled to the memory and configured to execute the instructions to receive, from a source, sequential data packets each identified by a sequence number. The processor may be further configured to receive, from an additional hearing device configured to also receive the sequential data packets, a first particular sequence number indicating a last of the sequential data packets received without discontinuity by the additional hearing device. The processor may further selectively transmit, based on the first particular sequence number and to the additional hearing device, a data packet included in the sequential data packets received from the source, the data packet having a sequence number that is based on the first particular sequence number.

The systems and methods described herein may advantageously provide many benefits to users of hearing devices. For example, the hearing devices described herein may provide audio to a user with fewer errors and/or delays than conventional hearing devices. The hearing devices may also be usable in environments with less reliable connectivity to audio sources than conventional hearing devices. For at least these reasons, the systems and methods described herein may advantageously increase performance, reliability, and ease of use for hearing device users compared to conventional hearing devices. These and other benefits of the systems and methods described herein will be made apparent herein.

As used herein, the term “audio packet” refers to any sample, portion, or other type of audio data representative of or otherwise associated with streaming audio that is provided by an audio source. An audio packet may be in any suitable format and may be transmitted in any suitable manner. While examples are described herein with reference to audio sources and audio packets, the systems and methods may be used by any suitable type of device with any data packet from any suitable type of data source.

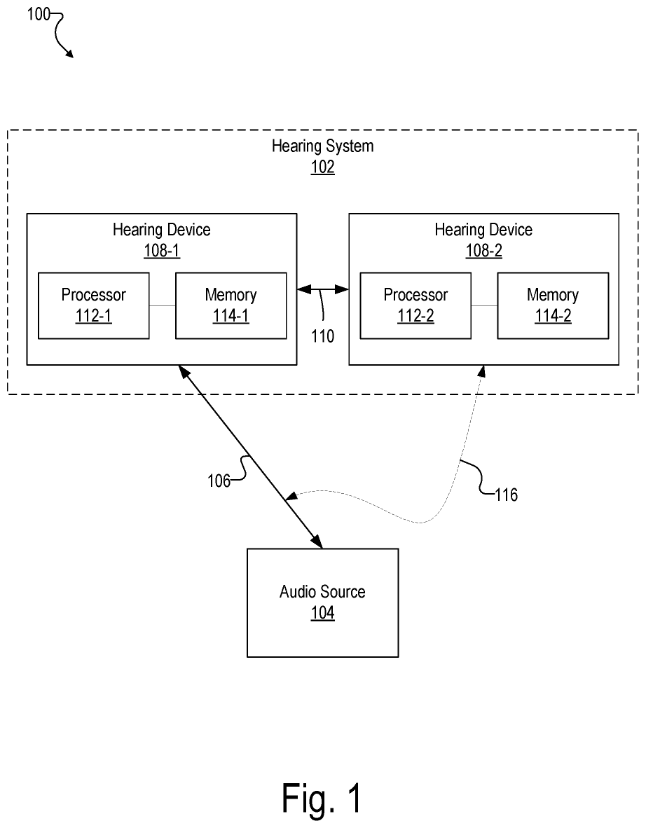

FIG. 1 illustrates an exemplary configuration 100 in which a hearing system 102 (e.g., a binaural hearing system) is configured to communicate with an audio source 104 by way of a selectively established wireless link 106. As shown, hearing system 102 includes a first hearing device 108-1 and a second hearing device 108-2 (collectively “hearing devices 108”). Hearing devices 108 may communicate one with another by way of a wireless support link 110.

Audio source 104 may include any computing device that outputs streaming audio (e.g., speech, music, or other audio content output) and that is capable of being wirelessly connected with one of hearing devices 108. For example, audio source 104 may be a mobile device (e.g., a mobile phone such as a smartphone, a tablet computer, a laptop computer, a mobile gaming device), a desktop computer, a television, a speaker, etc. As described herein, audio source 104 may wirelessly transmit streaming audio to hearing system 102 in the form of sequential audio packets (e.g., discrete units or pieces of data representative of the streaming audio).

Hearing devices 108 may each be implemented by any type of hearing device configured to provide or enhance hearing to a user of hearing system 102. For example, hearing devices 108 may each be implemented by a hearing aid configured to apply amplified audio content to a user, a sound processor included in a cochlear implant system configured to apply electrical stimulation representative of audio content to a user, a sound processor included in an electro-acoustic stimulation system configured to apply electro-acoustic stimulation to a user, a head-worn headset, an ear-worn ear-bud or any other suitable hearing prosthesis. In some examples, hearing device 108-1 is of a different type than hearing device 108-2. For example, hearing device 108-1 may be a hearing aid and hearing device 108-2 may be a sound processor included in a cochlear implant system.

As shown, each hearing device 108 includes a processor and a memory. For example, hearing device 108-1 includes a processor 112-1 and a memory 114-1. Likewise, hearing device 108-2 includes a processor 112-2 and a memory 114-2.

Processors 112 (e.g., processor 112-1 and processor 112-2) are configured to perform various processing operations, such as receiving and processing streaming audio transmitted by audio source 104. Processors 112 may each be implemented by any suitable combination of hardware and software.

Memories 114 (e.g., memory 114-1 and memory 114-2) may be implemented by any suitable type of storage medium and may maintain (e.g., store) data utilized by processors 112. For example, memories 114 may store data representative of an operation program that specifies how each processor 112 processes and delivers audio content to a user. To illustrate, if hearing device 108-1 is a hearing aid, memory 114-1 may maintain data representative of an operation program that specifies an audio amplification scheme (e.g., amplification levels, etc.) used by processor 112-1 to deliver acoustic content output by audio source 104 to the user. As another example, if hearing device 108-1 is a sound processor included in a cochlear implant system, memory 114-1 may maintain data representative of an operation program that specifies a stimulation scheme used by hearing device 108-1 to direct a cochlear implant to apply electrical stimulation representative of acoustic content output by audio source 104 to the user. As will be described below, memories 114 may maintain buffers within which audio packets received from audio source 104 may be stored.

Hearing devices 108 may communicate with each other (e.g., by transmitting data) by way of a wireless support link 110 that interconnects hearing devices 108. Wireless support link 110 may include any suitable wireless communication link as may serve a particular implementation.

To facilitate communication between hearing system 102 and audio source 104, one of hearing devices 108 may establish a wireless link with audio source 104. For example, as shown in FIG. 1, hearing device 108-1 may establish wireless link 106 with audio source 104. Wireless link 106 may include a Bluetooth link (e.g., a Bluetooth classic link or a Bluetooth low energy link), a near field communication link, or any other suitable point-to-point link. To this end, hearing devices 108 and audio source 104 may each include a wireless interface configured to operate in accordance with any suitable wireless communication protocol.

Hearing device 108-1 may receive audio packets transmitted from audio source 104 over wireless link 106 in accordance with an acknowledgement-based transmission protocol (also referred to as an automatic repeat query (“ARQ”) protocol). This may allow hearing device 108-1 to render (e.g., process and play back) streaming audio from audio source 104.

The acknowledgement-based transmission protocol requires hearing device 108-1 to acknowledge successful receipt of an audio packet transmitted by audio source 104 before audio source 104 transmits a subsequent audio packet. Exemplary acknowledgement-based transmission protocols include stop-and-wait ARQ, go-back-N ARQ, and selective repeat ARQ. A Bluetooth communication protocol, for example, may use any of these acknowledgement-based transmission protocols.

It may be desirable for hearing device 108-2 to also render streaming audio from audio source 104 while hearing device 108-1 renders the streaming audio. However, in some examples, hearing device 108-2 cannot or does not establish its own wireless link with audio source 104 while hearing device 108-1 is connected with audio source 104 by way of wireless link 106. For example, the communication protocol used by hearing devices 108 and audio source 104 to establish wireless links therebetween may not allow both hearing devices 108 to be concurrently connected to audio source 104.

In these examples, hearing device 108-2 may receive the audio packets transmitted from audio source 104 by eavesdropping on wireless link 106. This eavesdropping is illustrated by dashed line 116 in FIG. 1. Hearing device 108-2 may eavesdrop on wireless link 106 by passively listening to (e.g., having access to) data traffic (e.g., audio packets) transmitted between audio source 104 and hearing device 108-1. The eavesdropping may be done without audio source 104 being aware that hearing device 108-2 is accessing the data traffic and without hearing device 108-2 transmitting any data to audio source 104.

To enable eavesdropping by hearing device 108-2 on wireless link 106, hearing device 108-1 may transmit, over wireless support link 110, eavesdropping instructions to hearing device 108-2. The eavesdropping instructions may include information (e.g., frequency hopping sequence information, clock frequency and phase offset information, encryption key information, address information, etc.) that allows hearing device 108-2 to detect audio packets that are wirelessly transmitted from audio source 104 to hearing device 108-1. Hearing device 108-2 may accordingly use the eavesdropping instructions to eavesdrop on wireless link 106.

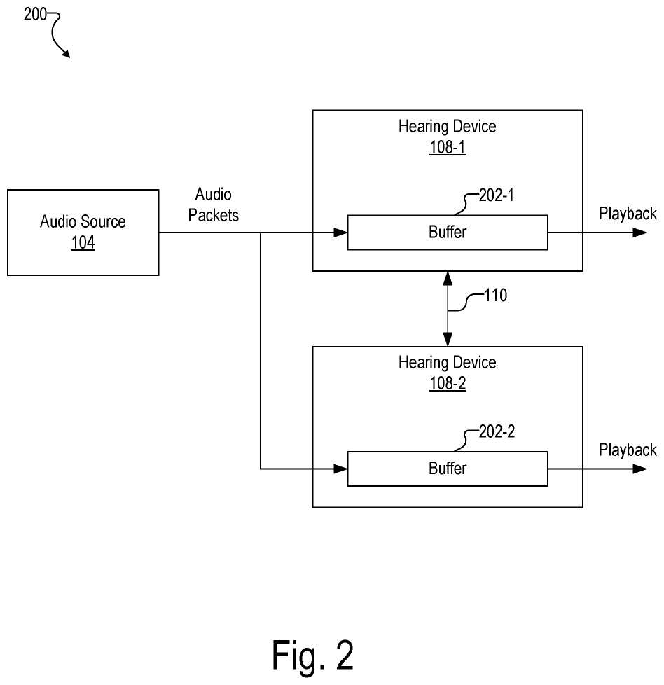

FIG. 2 illustrates an exemplary configuration 200 in which hearing devices 108 both render streaming audio from audio source 104. As shown, audio source 104 transmits sequential audio packets, which are received by both hearing device 108-1 and hearing device 108-2. As described in connection with FIG. 1, hearing device 108-1 may receive the audio packets over wireless link 106 and hearing device 108-2 may receive the audio packets by eavesdropping on wireless link 106.

As shown, hearing device 108-1 stores the audio packets in a buffer 202-1. Likewise, hearing device 108-2 stores the audio packets in a buffer 202-2. Buffer 202-1 and buffer 202-2 (collectively “buffers 202”) may be maintained within memory 114-1 and memory 114-2, respectively, and may each be of any suitable size (e.g., buffers 202 may each store any suitable number of audio packets).

Hearing devices 108 may render streaming audio from audio source 104 by playing back audio packets stored within buffers 202. For example, hearing device 108-1 may render streaming audio from audio source 104 by playing back audio packets stored within buffer 202-1. Likewise, hearing device 108-2 may render streaming audio from audio source 104 by playing back audio packets stored within buffer 202-2. In so doing, the audio packets that are played back may be removed from buffers 202. Hearing devices 108 may use any suitable processing technique to play back audio packets stored within buffers 202.

Playback of audio packets in buffers 202 may occur while additional audio packets are being received and stored within buffers 202. In this manner, buffers 202 may allow continuous rendering of streaming audio from audio source 104 as the audio is generated and transmitted by audio source 104.

An audio packet may be stored in a buffer (e.g., one of buffers 202) in any suitable manner. For example, an encoded and/or compressed version of an audio packet (instead of the audio packet itself) may be stored in a buffer.

In some instances, either hearing device 108-1 or hearing device 108-2 may miss (i.e., not receive) an audio packet, resulting in a discontinuity in received audio packets. Audio packets may be missed for various reasons, such as a transmission error, quality of a connection between hearing devices 108 and audio source 104, etc. Additionally, hearing devices 108 may discard audio packets for various reasons (e.g., an audio packet received with errors, etc.) which may be treated as a missed audio packet. When one of hearing devices 108 (e.g., hearing device 108-1) misses (or discards) an audio packet, the other hearing device 108 (e.g., hearing device 108-2) may relay the audio packet to hearing device 108-1. Receiving the missed audio packet from hearing device 108-2 may be more efficient than requesting a retransmission from audio source 104, as wireless support link 110 may be more stable than wireless link 106. However, as audio packets may be sent by audio source 104 asynchronously, it may not be obvious when either of hearing devices 108 has missed an audio packet. Hearing devices 108 may not determine that an audio packet has been missed until a subsequent audio packet in a sequence of audio packets is received. Thus, it may not be obvious when either of hearing devices 108 should relay audio data to the other.

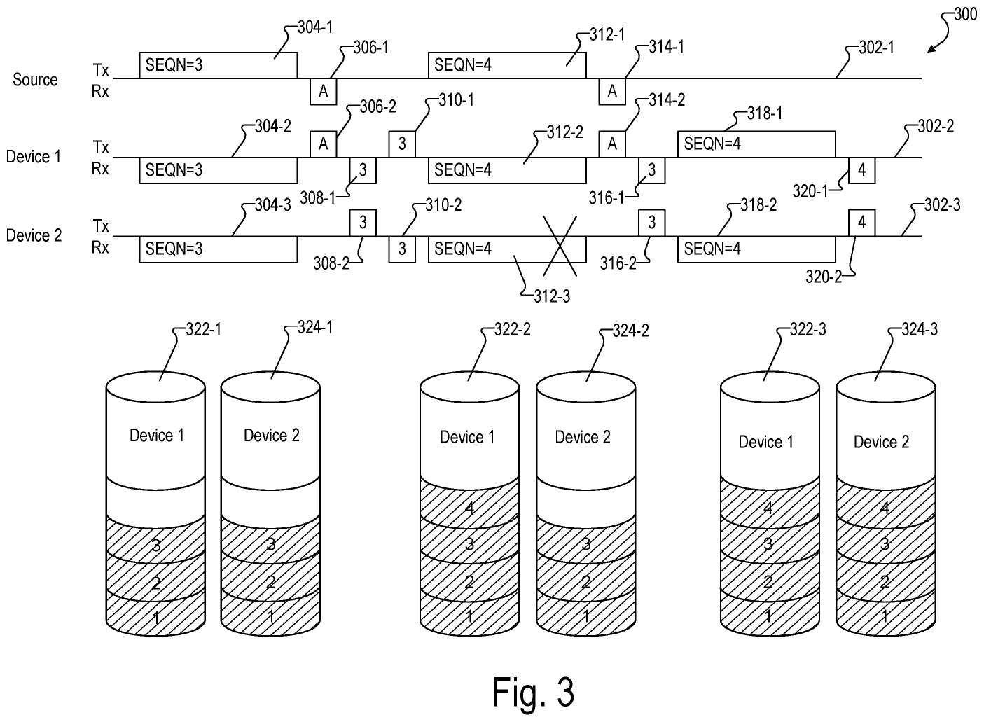

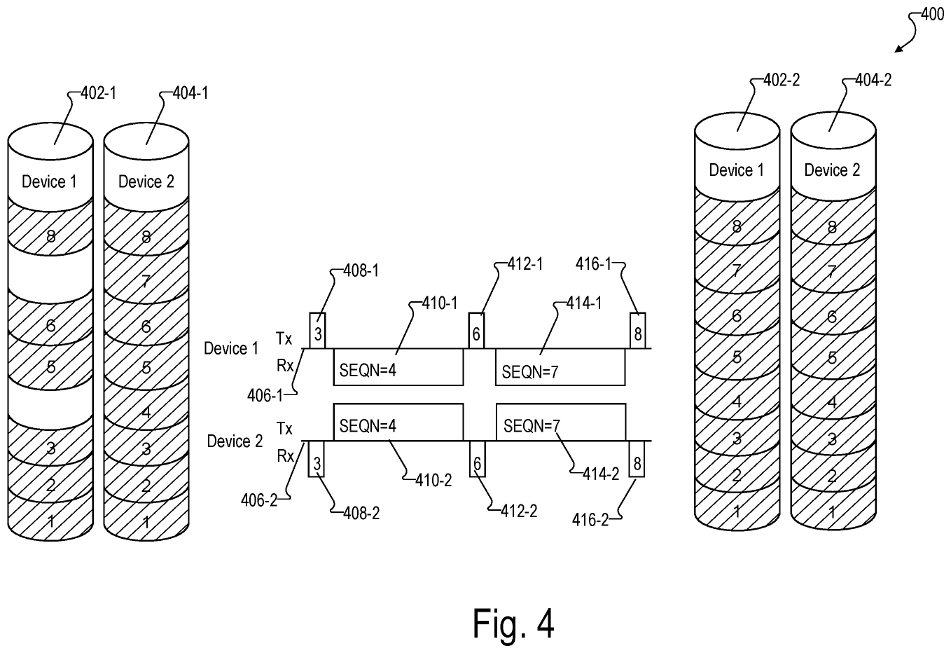

Audio packets may each be identified by a sequence number. For example, audio packets may include sequence numbers that can be used to identify each audio packet. Additionally or alternatively, sequence numbers may be assigned to audio packets by hearing devices 108. Hearing devices 108 may periodically transmit to each other a sequence number of a last of the sequential audio packets received without discontinuity. As hearing devices 108 receive the transmitted sequence number, if either one of hearing devices 108 has received an audio packet that is next in sequence after the received sequence number, the one of hearing devices 108 may autonomously transmit to the other of hearing devices 108 the audio packet that is next in sequence. In this manner, both hearing devices 108 may efficiently be kept synchronized and up to date in received audio packets. Examples are described herein with reference to FIGS. 3 and 4.

FIG. 3 illustrates an exemplary diagram 300 that shows an algorithm for relaying data between hearing devices (e.g., hearing devices 108) received from an audio source (e.g., audio source 104). Diagram 300 includes a line 302-1 showing data transmitted and received by audio source 104. A line 302-2 shows data transmitted and received by hearing device 108-1 and a line 302-3 shows data transmitted and received by hearing device 108-2. In this example, line 302-1 shows a block 304-1 indicating a transmitting of a first audio packet with a sequence number of 3 by audio source 104. Line 302-2 and line 302-3 show hearing device 108-1 and hearing device 108-2, respectively, receiving the first audio packet with a block 304-2 and a block 304-3, respectively. Line 302-2 shows hearing device 108-1 transmitting an acknowledgement of receiving the first audio packet with a block 306-2. Line 302-1 shows audio source 104 receiving the acknowledgement with a block 306-1.

Additionally, diagram 300 shows states of corresponding buffers (e.g., buffers 202) of hearing devices 108. For example, a buffer 322-1 shows buffer 202-1 after hearing device 108-1 receives the first audio packet. In this example, hearing device 108-1 has previously received audio packets with sequence numbers 1 and 2, and so buffer 322-1 shows audio packets 1, 2, and 3. Likewise, a buffer 324-1 shows buffer 202-2 after hearing device 108-2 receives the first audio packet. Hearing device 108-2 has also previously received audio packets with sequence numbers 1 and 2, so buffer 324-1 also shows audio packets 1, 2, and 3. Thus, for both hearing device 108-1 and hearing device 108-2, a last sequential audio packet received without discontinuity is audio packet 3. Therefore, hearing device 108-1 transmits the sequence number 3 to hearing device 108-2 and, vice versa, 108-2 transmits the sequence number 3 to hearing device 108-1. This transmitting and receiving are shown in blocks 308 (e.g., block 308-2 and block 308-1) and blocks 310 (e.g., block 310-1 and block 310-2). As neither hearing device 108-1 nor hearing device 108-2 has yet received any subsequent audio packets to audio packet 3, both hearing devices 108 are up to date and neither transmits audio data to the other.

Next, audio source 104 transmits a second audio packet (e.g., audio packet with sequence number 4), as shown by a block 312-1. In this example, hearing device 108-1 receives the second audio packet (as shown by a block 312-2), while hearing device 108-2 does not (as shown by a block 312-3 that is crossed out).

Correspondingly, a buffer 322-2 shows buffer 202-1 having received audio packet 4 and thus holding audio packets 1-4. A buffer 324-2 shows buffer 202-2 having missed audio packet 4, and thus holding audio packets 1-3. The sequence number of the last received audio packet without discontinuity for hearing device 108-1 is 4, while for hearing device 108-2 the sequence number is 3. Therefore, a block 316-2 shows hearing device 108-2 transmitting the sequence number 3 to hearing device 108-1 and a block 316-1 shows hearing device 108-1 receiving the sequence number 3 from hearing device 108-2.

In response, as hearing device 108-1 has received audio packet 4 and as receiving the sequence number 3 from hearing device 108-2 indicates to hearing device 108-1 that hearing device 108-2 has not, hearing device 108-1 transmits audio packet 4 to hearing device 108-2. This transmitting is indicated in a block 318-1, and a receiving of audio packet 4 by hearing device 108-2 is indicated in a block 318-2. Consequently, hearing device 108-2 also has audio packets 1-4, as a buffer 324-3 shows a state of buffer 202-2 after receiving audio packet 4 from hearing device 108-1. Thus, hearing device 108-2 transmits to hearing device 108-1 the sequence number 4, as audio packet 4 is now the last audio packet received without discontinuity. This transmitting is shown by a block 320-2, and a receiving by hearing device 108-1 of the transmitting is shown by a block 320-1.

In this manner, hearing devices 108 may transmit sequence numbers to each other indicating a last sequential audio packet received without discontinuity. Hearing devices 108 may receive the transmitted sequence numbers and selectively transmit, in response, audio packets based on the received sequence numbers. As described, the audio packets may be transmitted based on the received sequence number, without an explicit request for a relaying of audio packets.

FIG. 4 illustrates another example diagram 400 for relaying data between hearing devices (e.g., hearing devices 108). Diagram 400 shows states of buffers (e.g., buffers 202) for hearing devices 108 that indicate audio packets that were received from an audio source (e.g., audio source 104) and audio packets that were missed. For example, a buffer 402-1 shows a state of buffer 202-1 that indicates that hearing device 108-1 received audio packets 1-3, audio packets 5, 6, and 8, but missed audio packet 4 and audio packet 7. A buffer 404-1 shows a state of buffer 202-2 that indicates that hearing device 108-2 has received audio packets 1-8. In this example, a last audio packet received without discontinuity by hearing device 108-1 starts with sequence number 3, as the first discontinuity is with audio packet 4. Thus, as shown by a block 408-1 on a line 406-1, hearing device 108-1 transmits to hearing device 108-2 the sequence number 3. A line 406-2 shows a block 408-2 that indicates hearing device 108-2 receives the transmitted sequence number 3. In response, hearing device 108-2 transmits audio packet 4 to hearing device 108-1, as indicated by a block 410-2. A block 410-1 shows hearing device 108-1 receives audio packet 4.

Subsequently, once hearing device 108-1 receives audio packet 4, the last audio packet received without discontinuity becomes audio packet 6, as audio packet 7 is missing and thus results in a discontinuity. Therefore, hearing device 108-1 transmits the sequence number 6 to hearing device 108-2, as shown by a block 412-1. Hearing device 108-2 receives the transmitted sequence number 6, as shown by a block 412-2. In response, hearing device 108-2 transmits audio packet 7 to hearing device 108-1, as shown by a block 414-2. Hearing device 108-1 receives audio packet 7, as shown by a block 414-1. By transmitting the sequence number of the last audio packet received without discontinuity in this manner, hearing device 108-1 may receive from hearing device 108-2 the missed audio packets without receiving audio packets that were already received correctly from audio source 104.

Once hearing device 108-1 receives audio packet 7, the last audio packet received without discontinuity becomes audio packet 8, which is also the last audio packet received without discontinuity by hearing device 108-2. In this manner, both hearing devices 108 are synchronized and updated with the audio packets transmitted by an audio source 104. Hearing device 108-1 transmits the sequence number 8 to hearing device 108-2 (shown by a block 416-1) and hearing device 108-2 receives the transmitted sequence number 8 (shown by a block 416-2). As hearing device 108-2 does not have any subsequent audio packets, hearing device 108-2 does not transmit audio data to hearing device 108-1. Rather, hearing device 108-2 may also transmit the sequence number 8 to hearing device 108-1 (not shown). Hearing device 108-1 may receive the transmitted sequence number 8 and also not transmit audio data to hearing device 108-2. Additionally, the updated sequence numbers transmitted by hearing device 108-1 may provide an acknowledgement to hearing device 108-2 that hearing device 108-1 correctly received the audio packets transmitted by hearing deice 108-2.

While the sequence numbers shown in diagram 300 and diagram 400 are 1-8, any suitable sequence numbers may be used. Sequence numbers may increase or decrease by any suitable increments or decrements. In some examples, sequence numbers may be a 16-bit number, resetting to 0 or 1 after reaching a maximum value. Thus, for example, a next sequence number after 65535 may be 0. In some examples, portions of sequence numbers may be transmitted rather than full sequence numbers. For instance, for a 16-bit sequence number, a least significant byte (or other suitable portion) of the sequence number may be transmitted rather than all 16 bits.

Additionally, there may be instances in which audio source 104 may reset or skip sequence numbers in transmitted audio packets (e.g., a logical link control and adaptation protocol (L2CAP) flush, audio/video synchronization, etc.). In such instances, in an example in which hearing device 108-1 missed a next audio packet, hearing device 108-1 may transmit a sequence number N. Hearing device 108-2 may not have an audio packet with sequence number N+1, as a block of sequence numbers have been skipped by audio source 104, but hearing device 108-2 may have an audio packet with a sequence number M that is later in sequence than N+1. As a result, hearing device 108-2 transmits to hearing device 108-1 audio packet M. Upon receiving audio packet M, hearing device 108-1 and determining M is later in sequence than N+1, hearing device 108-1 may ignore remaining discontinuities before M.

In some examples, the sequence number may not be included in the transmitted audio packets. Such sequence numbers may be calculated by the hearing device. The sequence number may be calculated in any suitable manner, for instance, as a basic incremental counter, based on other properties derived from the protocol (e.g., a reception timestamp, etc.), etc.

Furthermore, in some examples, a finer (or alternatively, coarser) granularity may be used than audio packets for relaying audio data. For instance, hearing devices 108 may split audio packets into subframes based on a codec or any other suitable algorithms. Hearing devices 108 may then transmit identifiers (e.g., a sequence number and a frame index) that identify missing subframes rather than entire audio packets. In response, hearing devices 108 may selectively transmit subframes of audio data rather than audio packets.

Additionally, while hearing devices 108 have been described in an eavesdropping topology with audio source 104, methods described herein may be performed to relay audio data by any devices receiving sequential audio data from an audio source.

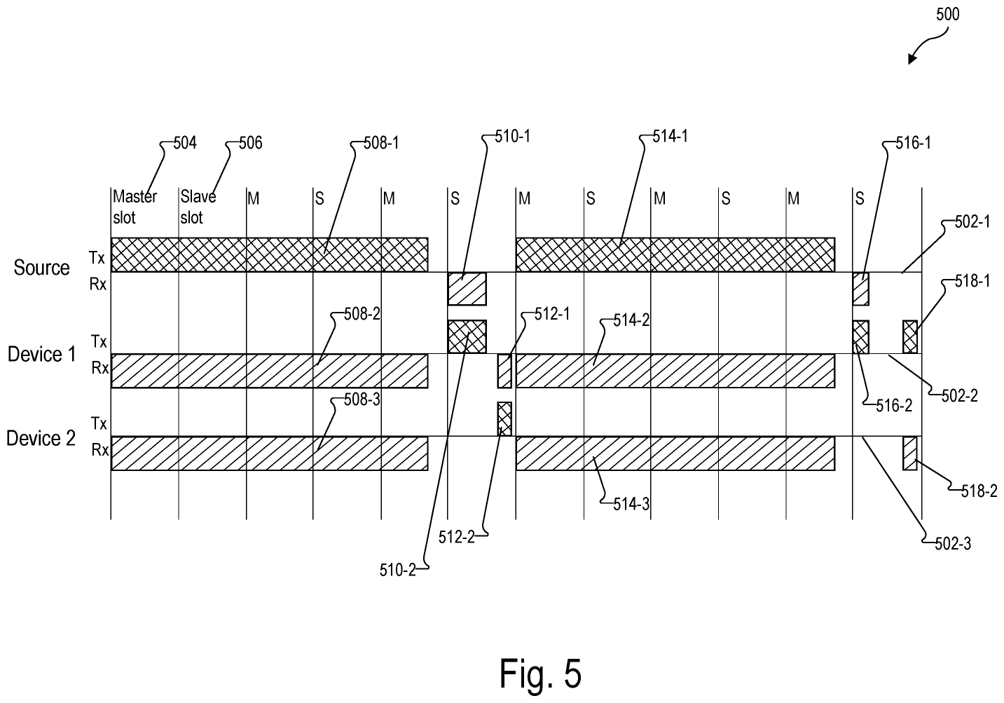

FIG. 5 illustrates an exemplary diagram 500 showing an example timing for relaying data by hearing devices (e.g., hearing devices 108). Diagram 500 shows a line 502-1 showing data transmitted and received by an audio source (e.g., audio source 104). A line 502-2 shows data transmitted and received by a hearing device (e.g., hearing device 108-1) and a line 502-3 shows data transmitted and received by an additional hearing device (e.g., hearing deice 108-2). The data transmitted and received by audio source 104 and hearing devices 108 may be transmitted and received using a dynamic time-division multiple access (TDMA) protocol (e.g., Bluetooth). The TDMA protocol may assign time slots, such as a master slot (e.g., a slot 504) for audio source 104 to start transmitting data and a slave slot (e.g., a slot 506) for hearing devices 108 to start transmitting data.

For instance, audio source 104 may start transmitting an audio packet at slot 504, a master slot designated for audio source 104 to start transmitting data. The audio packet transmission is shown by a block 508-1, which spans several time slots. A block 508-2 and a block 508-3 show a receiving of the audio packet by hearing device 108-1 and hearing device 108-2, respectively. A length of the audio packets may be configured such that a transmission of the audio packet spans an odd number (e.g., 3, 5, etc.) of time slots (or slightly less). By spanning an odd number of time slots, a next time slot after the transmission of the audio packet is a slave slot, which provides an opportunity for hearing device 108-1 to acknowledge receiving the audio packet. A block 510-2 shows a transmission by hearing device 108-1 to audio source 104 acknowledging the receiving of the audio packet. A block 510-1 shows a receiving of the acknowledgment by audio source 104. The transmitting of the acknowledgment message by hearing device 108-1 may take less time than a full time slot. As an example, a time slot may be 625 microseconds (μs) and an acknowledgment message may take up to 406 μs. Such timings may leave time at the end of the slave slot for hearing device 108-1 to transmit a sequence number to hearing device 108-2 or vice versa without introducing additional delay into the transmitting and receiving of audio data from audio source 104.

As shown, a block 512-2 shows hearing device 108-2 transmitting a sequence number to hearing device 108-1 and a block 512-1 shows hearing device 108-1 receiving the sequence number. As this transmitting and receiving finishes before the end of the slave slot, a next time slot may be available for audio source 104 to transmit a next audio packet.

As shown, a block 514-1 indicates a transmitting of the next audio packet by audio source 104, and a block 514-2 and a block 514-3 indicates a receiving of the next audio packet by hearing device 108-1 and hearing device 108-2, respectively. A block 516-2 indicates an acknowledgment transmitted by hearing device 108-1 in a subsequent slave slot that is received by audio source 104 at a block 516-1. In a remaining time of the slave slot, hearing device 108-1 transmits a sequence number to hearing device 108-2, as shown by a block 518-1 and a block 518-2. While this example shows hearing devices 108 alternating transmission of sequence numbers, any suitable algorithm may be used.

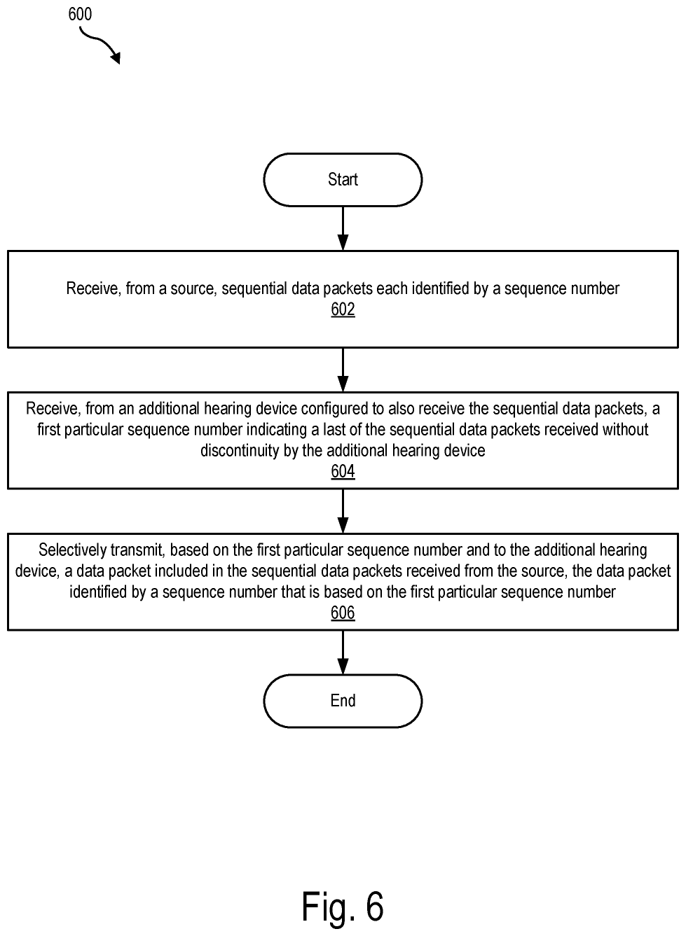

FIG. 6 illustrates an exemplary method 600. One or more of the operations shown in FIG. 6 may be performed by any of the hearing devices described herein. While FIG. 6 illustrates exemplary operations according to one embodiment, other embodiments may omit, add to, reorder, and/or modify any of the operations shown in FIG. 6.

In step 602, a processor of a hearing device receives, from a source, sequential data packets each identified by a sequence number. Step 602 may be performed in any of the ways described herein.

In step 604, the processor receives, from an additional hearing device configured to also receive the sequential data packets, a first particular sequence number indicating a last of the sequential data packets received without discontinuity by the additional hearing device. Step 604 may be performed in any of the ways described herein.

In step 606, the processor selectively transmits, based on the first particular sequence number and to the additional hearing device, a data packet included in the sequential data packets received from the source, the data packet having a sequence number that is based on the first particular sequence number. Step 606 may be performed in any of the ways described herein.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

1. A hearing device comprising:
a memory storing instructions; and
a processor communicatively coupled to the memory and configured to execute the instructions to:
receive, from a source, sequential data packets each identified by a sequence number;
receive, from an additional hearing device configured to also receive the sequential data packets, a first particular sequence number indicating a last of the sequential data packets received without discontinuity by the additional hearing device; and
selectively transmit, based on the first particular sequence number and to the additional hearing device, a data packet included in the sequential data packets received from the source, the data packet identified by a sequence number that is based on the first particular sequence number.

2. The hearing device of claim 1, wherein:
the processor is further configured to execute the instructions to determine that the hearing device has received the data packet; and
the transmitting is performed in response to the determining that the hearing device has received the data packet.

3. The hearing device of claim 1, wherein the processor is further configured to execute the instructions to:
transmit, to the additional hearing device, a second particular sequence number indicating a last of the sequential data packets received without discontinuity by the hearing device; and
selectively receive, from the additional hearing device, an additional data packet of the sequential data packets, the additional data packet identified by a sequence number that is based on the second particular sequence number.

4. The hearing device of claim 1, wherein the receiving the first particular sequence number occurs during a portion of a response slot configured for the hearing device to acknowledge to the source a receiving of a data packet.

5. The hearing device of claim 1, wherein:
the first particular sequence number is a sequence number of the last of the sequential data packets received without discontinuity; and
the sequence number of the data packet is a next sequence number after the first particular sequence number.

6. The hearing device of claim 1, wherein the sequential data packets are received from the source via a Bluetooth connection.

7. The hearing device of claim 6, wherein the additional hearing device is configured to also receive the sequential data packets via a Bluetooth eavesdropping topology.

8. The hearing device of claim 1, wherein the sequential data packets are received from the source via a Bluetooth eavesdropping topology.

9. The hearing device of claim 1, wherein:
the data packet is an audio packet; and
the processor is further configured to execute the instructions to render audio represented by the audio packet.

10. A system comprising:
a first hearing device and a second hearing device,
the first hearing device configured to:
receive, from a source, sequential data packets each including a sequence number;
receive, from the second hearing device, a first particular sequence number indicating a last of the sequential data packets received without discontinuity by the second hearing device; and
selectively transmit, based on the first particular sequence number and to the second hearing device, a data packet included in the sequential data packets received from the source, the data packet identified by a sequence number that is based on the first particular sequence number.

11. The system of claim 10, wherein the second hearing device is configured to:
receive, from the source, the sequential data packets;
transmit, to the first hearing device, the first particular sequence number;
selectively receive, from the first hearing device, the data packet;
receive, from the first hearing device, a second particular sequence number indicating a last of the sequential data packets received without discontinuity by the first hearing device; and
selectively transmit, based on the second particular sequence number and to the first hearing device, an additional data packet included in the sequential data packets received from the source, the additional data packet identified by a sequence number that is based on the second particular sequence number.

12. The system of claim 11, wherein the first hearing device is further configured to:
transmit, to the second hearing device, the second particular sequence number; and
selectively receive, from the second hearing device, the additional data packet.

13. The system of claim 10, wherein:
the first hearing device is further configured to determine that the first hearing device has received the data packet; and
the transmitting is performed in response to the determining that the first hearing device has received the data packet.

14. The system of claim 10, wherein the receiving the first particular sequence number occurs during a portion of a response slot configured for the hearing device to acknowledge to the source a receiving of a data packet.

15. The system of claim 10, wherein:
the first particular sequence number is a sequence number of the last of the sequential data packets received without discontinuity; and
the sequence number of the data packet is a next sequence number after the first particular sequence number.

16. The system of claim 10, wherein the sequential data packets are received from the source via a Bluetooth connection.

17. The system of claim 16, wherein the second hearing device is configured to also receive the sequential data packets via a Bluetooth eavesdropping topology.

18. A method comprising:
receiving, by a processor and from a source, sequential data packets each including a sequence number;
receiving, by the processor and from an additional processor configured to also receive the sequential data packets, a first particular sequence number indicating a last of the sequential data packets received without discontinuity by the additional processor; and
selectively transmitting, by the processor, based on the first particular sequence number and to the additional processor, a data packet included in the sequential data packets received from the source, the data packet identified by a sequence number that is based on the first particular sequence number.

19. The method of claim 18, further comprising determining, by the processor, that the processor has received the data packet; and
wherein the transmitting is performed in response to the determining that the processor has received the data packet.

20. The method of claim 18, further comprising:
transmitting, by the processor and to the additional processor, a second particular sequence number indicating a last of the sequential data packets received without discontinuity by the processor; and
selectively receiving, by the processor and from the additional processor, an additional data packet of the sequential data packets, the additional data packet identified by a sequence number that is based on the second particular sequence number.

21-25. (canceled)
